(19) United States
(12) Patent Application Publication
(10) Pub. No.: US 2008/0216125 A1
(43) Pub. Date: Sep. 4, 2008

(54) Mobile Device Collaboration

(75) Inventors: Shipeng Li, Beijing (CN); Yongguang Zhang, Beijing (CN); Guo Bin Shen, Beijing (CN); Yanlin Li, Beijing (CN)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 12/040,728

(22) Filed: Feb. 29, 2008

Related U.S. Application Data
(60) Provisional application No. 60/892,458, filed on Mar. 1, 2007.
(60) Provisional application No. 60/942,739, filed on Jun. 8, 2007.

(51) Int. Cl. H04N 7/16; H04N 11/02

(52) U.S. Cl. 725/62; 375/240.16; 375/E07.076

(57) ABSTRACT

Systems and methods are described for mobile device collaboration. An exemplary collaborative architecture enables aggregation of resources across two or more mobile devices, in such a manner that the aggregation of resources is practical even considering the miniaturized and limited battery power of most mobile devices. In a video implementation, the exemplary collaborative architecture senses when another mobile device is in close enough proximity to aggregate resources. The collaborative architecture applies an adaptive video decoder so that each mobile device can participate in playing back a larger and higher-resolution video across combined display screens than any single mobile device could playback alone. A cross-display motion prediction technique saves battery power by balancing the amount of collaborative communication between devices against the local processing that each device performs to display visual motion across the boundary separating displays.

### RELATED APPLICATIONS

This patent application claims priority to U.S. Provisional Patent Application No. 60/892,458 to Shen et al., entitled, “Mobile Device Collaboration,” filed Mar. 1, 2007 and incorporated herein by reference; and to U.S. patent application Ser. No. 11/868,515 to Peng et al., entitled “Acoustic Ranging,” filed Oct. 7, 2007 and incorporated herein by reference, which in turn claims priority to U.S. Provisional Patent Application No. 60/942,739 to Shen et al., entitled, “Mobile Device Collaboration,” filed Jun. 8, 2007, and incorporated herein by reference.

### BACKGROUND

Mobile communication and/or computing devices (“mobile devices”) are becoming indispensable in daily life, and most are equipped with both multimedia and wireless networking capabilities. Many new technologies have emerged to allow efficient exchanging of files (including media files, such as audio, video, flash, ring-tone etc.; and documents like WORD, POWERPOINT, PDF files, etc.). However, the full potential of resources in mobile devices have not been put to full advantage. For example, most mobile devices contain an array of resources that include one or more: input/output modules, microphones, speakers, cameras, displays, keypads, computing modules (e.g., CPU, memory); storage modules (e.g., SD card, mini SD card, CF card, microdrive); communication modules (i.e., radio and antenna, infrared ports); battery, stylus, software, etc. Many of these resources are limited, however, because of the miniature package size of many mobile devices and correspondingly the miniature storage capacity of the battery power supply. So, although mobile communication devices are now ubiquitous, the resources they contain are often constrained. What is needed is a way to combine resources across mobile devices to boost their capacity when multiple mobile devices are available.

### SUMMARY

Systems and methods are described for mobile device collaboration. An exemplary collaborative architecture enables aggregation of resources across two or more mobile devices, in such a manner that the aggregation of resources is practical even considering the miniaturized and limited battery power of most mobile devices. In a video implementation, the exemplary collaborative architecture senses when another mobile device is in close enough proximity to aggregate resources. The collaborative architecture applies an adaptive video decoder so that each mobile device can participate in playing back a larger and higher-resolution video across combined display screens than any single mobile device could playback alone. A cross-display motion prediction technique saves battery power by balancing the amount of collaborative communication between devices against the local processing that each device performs to display visual motion across the boundary separating displays.

This summary is provided to introduce the subject matter of mobile device collaboration, which is further described below in the Detailed Description. This summary is not intended to identify essential features of the claimed subject matter, nor is it intended for use in determining the scope of the claimed subject matter.

### BRIEF DESCRIPTION OF THE DRAWINGS

FIG. 1 is a diagram of an exemplary system for mobile device collaboration.

FIG. 2 is a block diagram of an exemplary collaborative architecture.

FIG. 3 is a diagram of example scenarios that take advantage of display screen aggregation.

FIG. 4 is a diagram of further example scenarios that take advantage of display screen aggregation.

FIG. 5 is a diagram of exemplary large array display screen aggregation of 21 cell phone display screens.

FIG. 6 is a diagram of exemplary video display aggregation.

FIG. 7 is a diagram of exemplary drag and drop file transfer between collaborating mobile devices.

FIG. 8 is a diagram of exemplary microphone aggregation and exemplary speaker aggregation.

FIG. 9 is a diagram of exemplary camera aggregation.

FIG. 10 is a diagram of an exemplary physical interlock between two mobile devices.

FIG. 11 is a flow diagram of an exemplary method of mobile device collaboration.

### DETAILED DESCRIPTION

Overview

This disclosure describes systems and methods for mobile device collaboration. In general, the techniques to be described herein enable two or more mobile devices, such as cell phones (SMARTPHONES, POCKET PCs, etc), to combine (“aggregate”) one or more resources. When aggregated, the combined resources typically provide a better, more powerful resource than any single mobile device could provide alone. Depending on implementation, the functional modules of a typical handheld device that can be aggregated include:
I/O modules, i.e., microphone/speaker(s), camera/display, and keypad;
computing modules, i.e., CPU, memory;
storage modules, i.e., SD card, mini SD card, CF card, microdrive;
communication modules, i.e., radio and antenna, IR;
battery, stylus, software, security schemes, etc.

An exemplary proximity detector, ranging scheme, or even a hardware interface triggers the ability to coalesce selected resources. Mobile devices become communicatively coupled via physical attachment, via short-range wireless connection, or via long-range wireless connections. Exemplary collaboration scenarios can arise from an infrastructure mode or an ad hoc mode.

An exemplary collaborative architecture described herein enables aggregation of resources across two or more mobile devices, in such a manner that the aggregation of resources is feasible even with the miniaturized and limited battery power supply of most mobile devices.

In a video implementation, the collaborative architecture applies an adaptive video decoder so that each mobile device can participate in playing back a larger and higher-resolution video across combined display screens than any single mobile device could playback alone. An exemplary cross-display motion prediction technique saves battery power by balancing the amount of collaborative communication between devices with the amount of processing that each device performs in order to display motion across the boundary between displays.

In another aspect, when two mobile device displays are aggregated, the collaboration makes sharing, copying, or moving files from one device to the other much easier: instead of multiple clicks, files can be shared by dragging and dropping across device displays. Various other resource aggregation scenarios are also described.

Exemplary System

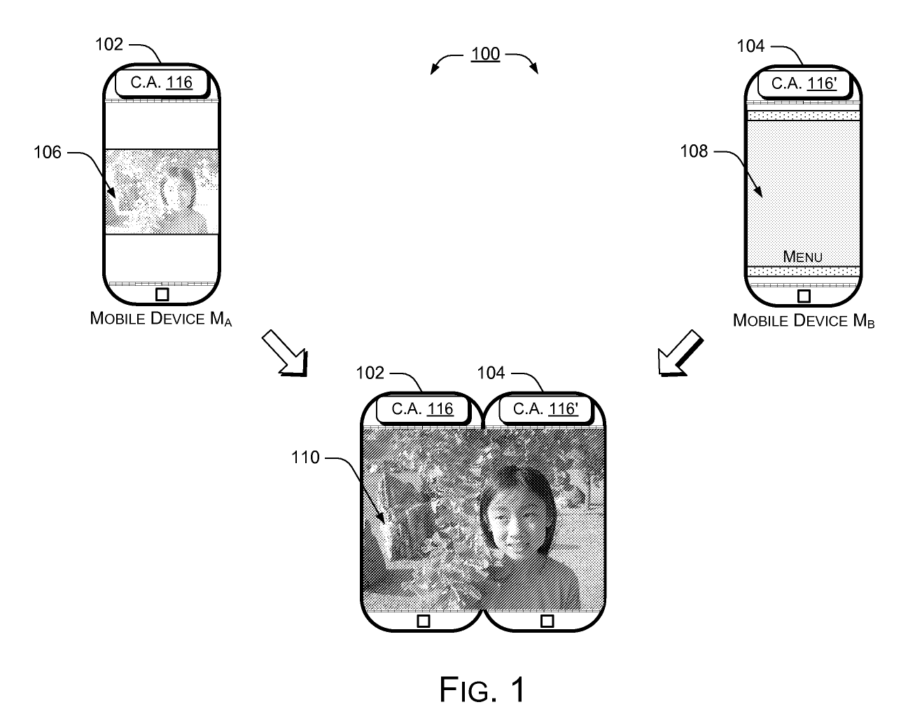

FIG. 1 shows an exemplary system 100, in which two mobile devices 102 and 104 are placed in close proximity to collaborate. Video aggregation is representatively described for the sake of description, but the exemplary collaboration applies to many other kinds of resource aggregation. Thus, the two mobile devices 102 and 104 collaborate to provide from their two standard displays 106 and 108 a larger, higher-resolution video display 110 than either phone could provide alone. That is, when the two phones 102 and 104 are in close enough proximity, the phones collaborate to automatically shift to the aggregated display 110. Then, higher-resolution video is played back across the combined screens 110 of the two mobile devices 102 and 104, placed side by side. This scenario is described because it is challenging and representative, and the results apply to other applications, such as collaborative mobile gaming and collaborative mobile authoring. The scenario is described in the context of only two mobile devices 102 and 104 because two devices define the most basic case.

Collaborating to ally two or more resources into a unified resource (or at least into two resources working together in tandem or in unison) imposes real-time, synchronous decoding and rendering requirements that are conventionally difficult to achieve because of the intrinsic complexity of video rendering and resource constraints such as limited processing power and battery life of mobile devices 102. Real-time playback implies at least 15 frames per second (fps) for typical mobile video, and normally 24 fps is expected, depending on how video clips are produced. Thus, this disclosure describes an exemplary collaborative half-frame decoding scheme that is very efficient and describes the design of a tightly coupled collaborative system architecture (C.A. 116) that aggregates resources of two or more devices to achieve the task.

Among the challenges presented by mobile device collaboration of video are the intrinsic complexity of video on account of recursive temporal frame dependency and motion compensated prediction, in view of the inherent constraints of mobile devices 102, such as limited processing power and short battery capacity. The exemplary mobile device collaboration overcomes these challenges based on the tightly coupled collaborative system architecture 116. The exemplary collaborative half-frame decoding technique significantly reduces the computational complexity of decoding and further optimizes decoding for improved energy efficiency, e.g., in an exemplary technique referred to herein as guardband-based collaborative half-frame decoding.

In the collaborative scenario of FIG. 1, one device 102 has downloaded from the Internet or otherwise obtained a high-resolution video that has a video size approximately twice its screen size 106. Given that the screens 106 and 108 of many mobile devices 102 are relatively small, this is a reasonable approximation.

The two devices 102 and 104 can communicate effectively and directly via high-speed local wireless networks such as WiFi and Bluetooth, which are equipped in many cell phones and PDAs. In one implementation, the two devices 102 and 104 are homogeneous, i.e., with same or similar software and hardware capabilities, while in other implementations the homogeneity is relaxed.

In one implementation, video decoding and playback are in real-time and must be in sync between the two devices 102 and 104. An effective synchronization mechanism is in place to ensure the same video frame is rendered at two devices simultaneously, even if their clocks are out of sync.

The collaborative architecture 116 must be able to work in a resource-constrained environment in which processing power, memory, and battery life may be barely enough for each device 102 to just decode a video of its own screen size. The collaborative architecture 116 minimizes energy consumption during processing and communication so that a battery charge can last as long as possible. The aggregation of resources is flexible and adaptive. The exemplary collaborative architecture 116 can expand the video onto two or more devices or shrink the video onto one display screen alone 106 as the other device 104 comes and goes.

Unlike conventional screen aggregation work where screens from multiple personal computers are put together to form a larger virtual screen, the exemplary collaboration architecture 116 is more challenging and sophisticated because previous techniques, such as remote frame buffer protocols, would require too much processing power and communication bandwidth on mobile devices 102 and 104. Naive approaches such as having one device 102 do full decoding and then send half-frames to the peer device 104, or having both devices do full decoding and each display only half, would quickly saturate and consume the limited resources of mobile devices 102 and 104.

A tightly coupled collaborative and aggregated computing model for resource-constrained mobile devices supports aggregated video application. The collaborative half-frame video decoding scheme intelligently divides the decoding task between the two (or more) devices 102 and 104 and achieves a real-time playback within the given constraints of mobile devices 102 and 104. The scheme is further optimized to improve energy efficiency.

In one implementation, the exemplary system 100 also supports the many existing scenarios for easy sharing (pictures, music, ringtones, documents, etc.) and ad hoc gaming. There are two possible ways of achieving synchronized viewing/playing, one is real-time and the other is not. For the real-time case, it can be achieved by streaming the video from the predicted point to be synch-played back. For the non-real-time case, the entire video file can be transmitted, but tags are added to indicate the point at which the video is being shared. The player understands and interprets each tag and offers options to play either from the beginning or from the tagged point.

Exemplary Collaborative Architecture (Video Aggregation Example)

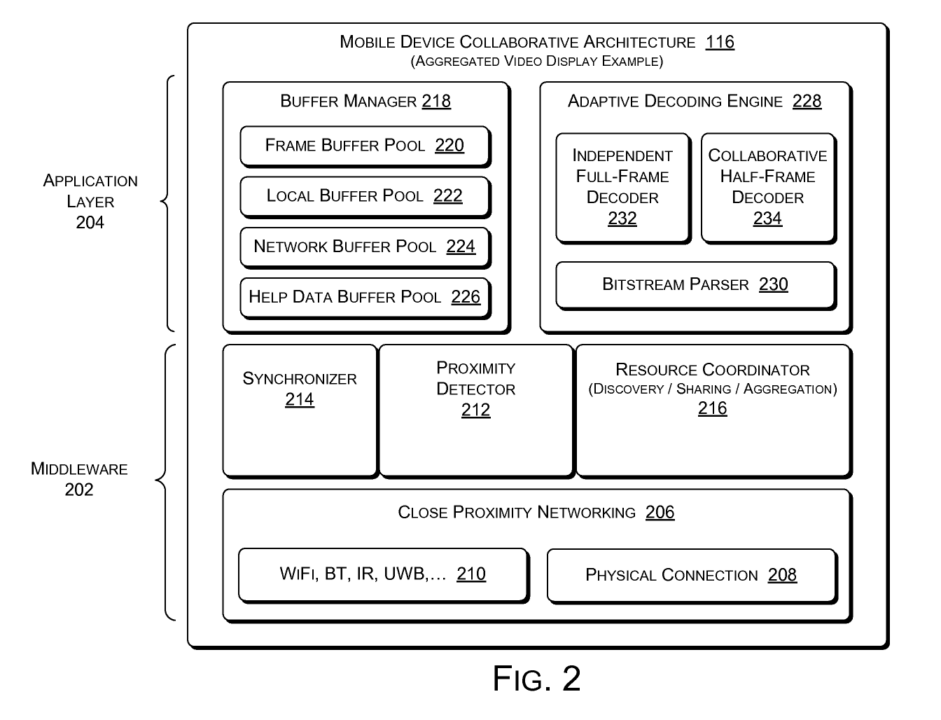

FIG. 2 shows the exemplary collaborative architecture 116 of FIG. 1, in greater detail. Layout and components of the collaborative architecture 116 are now described at some length, prior to a detailed description of example operation of the collaborative architecture 116. The illustrated implementation of FIG. 2 is only one example configuration, for descriptive purposes. Many other arrangements and components of an exemplary collaborative architecture 116 are possible within the scope of the subject matter. Implementations of the exemplary collaborative architecture 116 can be executed in various combinations of hardware and software.

The illustrated implementation of the mobile device collaborative architecture 116 includes a middleware layer 202 and an applications layer 204. A close proximity networking layer 206 enables physical connection 208 and/or wireless modalities 210, such as WiFi, Bluetooth, Infrared, UWB, etc. The collaborative architecture 116 also includes a proximity detector 212, a synchronizer 214; and a resource coordinator 216, for such functions as discovery, sharing, and aggregation of resources.

In the applications layer 204, a buffer manager 218 administrates a frame buffer pool 220, a local buffer pool 222, a network buffer pool 224, and a help data pool 226. An adaptive decoding engine 228 includes a bitstream parser 230, an independent full-frame decoder 232, and a collaborative half-frame decoder 234.

Unlike conventional loosely-coupled distributed systems, e.g., those for file sharing, the exemplary mobile device collaborative architecture 116 has a tightly coupled system that enables not only networking, but also computing, shared states, shared data, and other aggregated resources. In the specific case of aggregated video display, the collaborative architecture 116 includes the common modules proximity detector 212, synchronizer 214, and resource coordinator 216. Omitted are those modules such as access control that are otherwise important in conventional loosely-coupled distributed systems, because the design of the video aggregation described herein already presupposes close proximity for the display resources to aggregate.

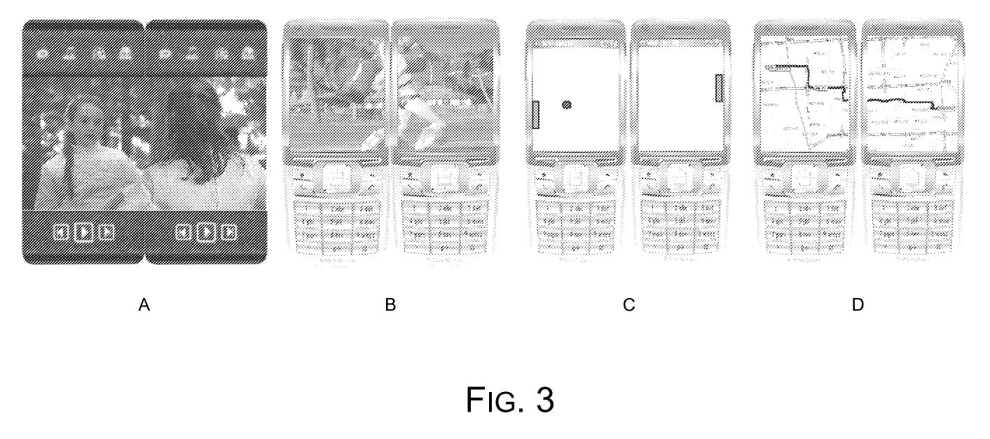

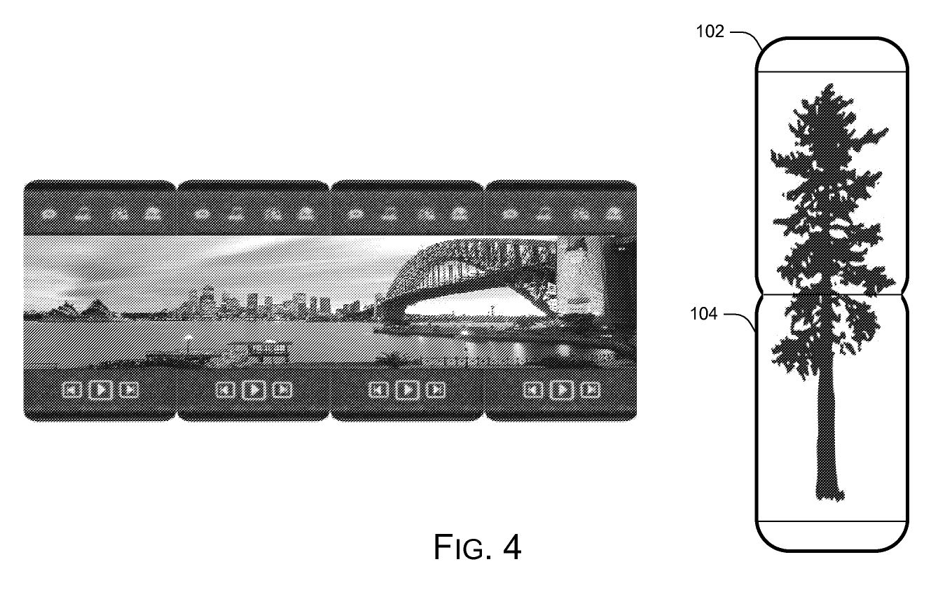

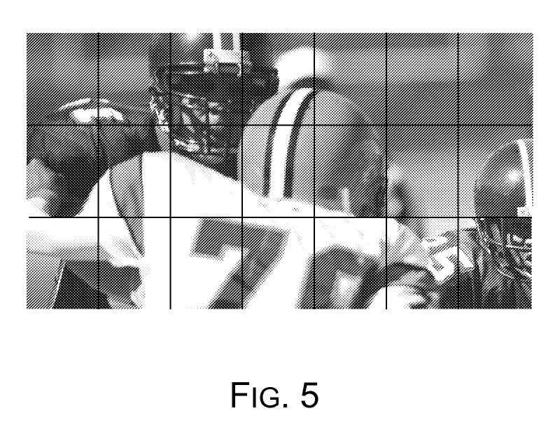

FIGS. 3, 4, and 5 show example scenarios of display screen aggregation made possible via the exemplary collaborative architecture 116 of FIG. 2, or variations thereof. FIG. 3(A) shows aggregated display screen providing a higher-resolution, larger screen. FIG. 3(B) shows automatic switching to a larger display area upon sensing proximity of additional phone(s). FIG. 3(C) shows an aggregated pong game, with separate controls. FIG. 3(D) shows trans-screen display and interactive user input. FIG. 4 shows that multiple phones may be aggregated horizontally or vertically. FIG. 5 shows large array aggregation of the display screens of 21 cell phones.

Exemplary Middleware Components

In FIG. 2, the common modules are positioned as the middleware layer 202, sitting on top of a conventional operating system, with the video aggregation application in the applications layer 204. The roles of these various modules will now be elaborated.

The bottom substrate of the exemplary collaborative architecture 116 is the close proximity networking layer 206, which sits directly on top of a conventional networking layer but further abstracts popular wireless technologies 210 into a unified networking framework. The close proximity networking layer 206 also incorporates available physical connections 208 (e.g., via wire or hardware interface). The goal of the close proximity networking layer 206 is to automatically set up a network between two mobile devices 102 and 104, without involving the users, such that resource discovery and aggregation can be performed effectively.

In one implementation, the collaborative architecture 116 manages different wireless technologies into a unified framework. Thus, the collaborative architecture 116 can use both Bluetooth and WiFi, and can save energy by dynamically switching between them, depending on the traffic requirements.

The proximity detector 212 has a primary function of ensuring a close proximity between devices for resource aggregation. Depending on different application requirements, approximate or precise proximity information can be obtained at different system complexities. For example, for typical applications, the collaborative architecture 116 can use a simple radio signal strength-based strategy to determine a rough estimate of distance between mobile devices 102 and 104, thereby involving only wireless signals. Typically, radio signal strength is indicated by receiving a signal strength index (RSSI), which is usually available from wireless NIC drivers. If high precision is desired, then with additional hardware the collaborative architecture 116 can use both wireless signals and acoustic or ultrasonic signals to obtain precision up to a few centimeters.

In the case of aggregated video display, the proximity detection is mainly for the purpose of user convenience. Therefore, there is only a low precision requirement to determine the arrival or departure of the other device. A simple RSSI-based strategy suffices for such a scenario. Lacking a universal model that can indicate the proximity of two devices using solely RSSI, and considering that the video display aggregation is intentional, a simple heuristic arises: when RSSI is high (e.g., −50 dbm of WiFi signal on DOPOD 838), the collaborative architecture 116 informs the user that another device is nearby and offers the user the opportunity to confirm or reject the aggregation opportunity or request. Notification is sent to the resource coordinator module 216 if confirmed. When RSSI decreases significantly (under a normal quadratic signal strength decaying model) the collaborative architecture 116 simply concludes that the other device has left and informs the resource coordinator module 216 accordingly. In one implementation, the proximity detector 212 uses acoustic signaling to achieve higher proximity detection accuracy (described further below).

The resource aggregation features of the collaborative architecture 116 aim to operate the mobile devices 102 and 104 in synchrony. The synchronization can be achieved, at different difficulty levels, either at the application level 204 or at the system level. Synchronizing the mobile devices 102 and 104 to a high precision can rely on either network time protocol or the fine- grained reference broadcasting synchronization mechanism, e.g., within one millisecond. Such system level synchronization is difficult to achieve, however, and is sometimes not necessary for specific applications, especially multimedia applications. In one implementation, the collaborative architecture 116 adopts an application level synchronization strategy, which satisfies synchronization needs and is easy to implement.

In the case of video display aggregation, since the collaborative architecture 116 displays each video frame across both screens 106 and 108, the two respective video playback sessions should remain synchronized at the frame level. This implies that a tolerable out-of-sync range is only approximately one frame period, e.g., 42 milliseconds for 24 fps video. Considering the characteristics of the human visual system, the tolerable range can actually be even larger. It is well known in the video processing arts that humans perceive a continuous playback if the frame rate is above 15 fps, which translates to a 66 millisecond tolerable range.

It is worth noting that the goal of the synchronization engine 214 is to sync the display of video, not the two devices 102 and 104. Toward this end, the collaborative architecture 116 uses the video stream time as the reference and relies on an estimation of round-trip-time (RTT) of wireless signals to sync the video playback. The content-hosting device 102 performs RTT measurements; and after once obtaining a stable RTT, the content-hosting device 102 notifies the client 104 to display the next frame while waiting half of the RTT interval before displaying the same frame. Such RTT-based synchronization procedures are performed periodically throughout the video session. In one implementation, a typical stable RTT value is within 10 milliseconds and the RTT value stabilizes quickly in a few rounds.

The resource coordinator 216 typically has a double role: one role discovers resources to be aggregated or processed by the aggregation, including information resources such as files being shared. This also includes computing resources, for example, whether the other device is capable of performing certain tasks. The other role is to coordinate the resources in order to collaboratively perform a task, and to achieve load balance among devices, if needed, by shifting around tasks.

Application Layer: Exemplary Aggregated Video Display Application

In the aggregated video display application, an XML-based resource description schema can be used for resource discovery purposes, and indicates video files available on a device and associated basic features, such as resolution, bit rate, etc. The resource description schema can also track basic system configuration information, such as processor information, system memory (RAM), and registered video decoder. In one implementation, the resource coordinator 216 only checks capabilities of a newly added device 104 and informs the content hosting device 102 about the arrival (if the new device 104 passes a capability check), or informs the content hosting device 102 of the departure of the other device 104. In another implementation, the resource coordinator 216 also monitors system energy drain and dynamically shifts partial decoding tasks between the devices.

Other components of the exemplary mobile device collaborative architecture 116 shown in FIG. 2 are also specific to the task of aggregated video display. For example, in one implementation, the buffer manager 218 manages four buffer pools: the frame buffer pool 220, the helping data buffer pool 226; and two bitstream buffer pools: the local bitstream buffer (LBB) pool 222 and the network bitstream buffer (NBB) pool 224.

In one implementation, one of the mobile devices 102 adopts the role of video content host and performs some bitstream processing for the other mobile device 104, which becomes aggregated to the host device 102. Thus, a host 102 (or server) and client 104 relationship is set up. These roles, as they apply to the exemplary mobile device collaborative architecture 116, will be described further below under description of the operation of the collaborative architecture 116.

The frame buffer pool 220 contains several buffers to temporarily hold decoded video frames if they have been decoded prior to their display time. Such buffers sit in between the decoder 228 and the display and are adopted to absorb the jitter caused by the mismatches between a variable decoding speed and the fixed display interval. The helping data buffer pools 226 consist of, e.g., two small buffers that hold and send/receive cross-device collaboration data to be transferred between devices 102 and 104.

The two bitstream buffer pools (the local LBB pool 222 and the network NBB pool 224) hold two half-bitstreams that are separated out by a pre-parser module 230 in the adaptive decoding engine 228, e.g., for the host device 102 itself and the other device 104, respectively. The bitstream in the NBB pool 224 will be transferred from the host device 102 to the other device 104. In the content hosting device 102, two bitstream buffer pools are used 222 and 224. However, only one of them (i.e., the NBB pool 224) is operational when the other device 104 is acting as the “client” device 104. The reasons for adopting the NBB pool 224 at the content hosting device 102 is at least three-fold: 1) to enable batch transmission (e.g., using WiFi) for energy saving; 2) to allow a fast switch back to single screen playback if the other device 104 leaves beyond a proximity threshold; and 3) to emulate the buffer consumption at the client device 104 so that when performing an exemplary push-based bitstream delivery (to be described below), the previously sent but unconsumed bitstream data will not be overrun or overwritten. Based on the fact that in exemplary video display aggregation the two devices 102 and 104 playback synchronously, the content hosting device 102 can know exactly what part of the receiving buffer of the client can be reused in advance.

The exemplary dedicated buffer manager 218 provides a very preferable implementation of the collaborative architecture 116, as the buffer manager 218 clarifies the working process flow and helps to remove memory copies, which is a very costly issue on mobile devices 102 and 104. In one implementation, the buffer manager 218 overwhelmingly uses pointers throughout the processes. Moreover, using the multiple buffers greatly helps overall performance by mitigating dependency among several working process threads.

The adaptive decoding engine 228 is a core component of the aggregated video display implementation of the collaborative architecture 116. In one implementation, the adaptive decoding engine 228 consists of the three components, the bitstream pre-parser 230, the independent full-frame decoder 232 (e.g., an independent full-frame-based fast DCT-domain down-scaling decoder), and the collaborative half-frame decoder 234 (e.g., the “guardband-based” collaborative half-frame decoder-to be described in detail below).

The bitstream pre-parser 230 parses the original video bitstream into two half bitstreams prior to the time of their decoding, and also extracts motion vectors. The resulting two half bitstreams are placed into the two bitstream buffers, i.e., in the local buffer pool 222 and the network buffer pool 224.

As detected and indicated by the resource coordinator 216, if only a single display 106 is available, then the independent full-frame decoding engine 232 will be called, which retrieves bitstreams from both bitstream buffers in the local LBB 222 and the network NBB pool 224, and directly produces a down-scaled version of the original higher-resolution video to fit the screen size, eliminating the explicit downscaling process. For the case of a single display 106, the decoded frame is rotated to match the orientation of video to that of the display screen 106. The rotation process can be absorbed into a color space conversion process. If two screens 106 and 108 are available, the guardband-based collaborative half-frame decoder 234 will be activated. The content hosting device 102 decodes the bitstream from buffers in the LBB pool 222 and sends those in the NBB pool 224 to the other device 104 and, correspondingly, the other device 104 receives the bitstream into its own NBB pool 224 and decodes from there. The two mobile devices 102 and 104 work concurrently and send to each other the helping data 226 (to be described below) periodically, on a per-frame basis. The two decoding engines 232 and 234 can switch to each other automatically and on the fly, under the direction of the resource coordinator 216.

Separating the networking, decoding, and display into different processing threads provides a preferred implementation. The alternative-not using multiple threads-loses the benefit of using the multiple buffers, which then provide only a limited benefit. Moreover, because mobile devices 102 and 104 have limited resources, it is of some importance to assign correct priority levels to different threads. In one implementation, a higher priority (Priority 2) is assigned to the display thread and the networking thread, since the collaborative architecture 116 needs to ensure synchronous display of the two devices 102 and 104 and does not want the decoding process to be blocked on account of waiting for bitstream data or helping data. The decoding thread can be assigned a lower priority (Priority 1) by default, which is still higher than other normal system threads, but will be dynamically changed if at risk of display buffer starvation. For sporadic events like proximity detection, Priority 2 can be assigned to ensure prompt response to the arrival or departure of the other device 104.

Exemplary Video Display Aggregation

Operation of the mobile device collaborative architecture 116 is now described in the example context of video display aggregation. The exemplary collaborative architecture 116 aggregates displays 106 and 108 to form a larger display 110 from the two smaller screens, as shown in FIG. 1. The larger display 110 offers much better viewing experience and can be used for playing back higher-resolution video, gaming, a map viewer, etc, than can be provided by a single device 102. In one implementation, when the two devices 102 and 104 are placed in proximity, they effectively playback a higher-resolution video using the united displays 110. In one implementation, each of the mobile devices 102 and 104 plays a visual half of the video contents.

Exemplary screen aggregation is performed dynamically. That is, the collaborative architecture 116 can easily fall back to a single screen 106 when the other device 104 leaves or becomes so far away that screen aggregation no longer makes sense. The collaborative architecture 116 may also fall back to using a single screen 106 or, e.g., reducing to half-resolution, when there is need, such as when the remaining power of the mobile device 102 drops below a certain level. The collaborative architecture 116 can revert to single screens 106 and 108 at half resolution, or can dedicate the video to a single screen of either device through a switch button, e.g., as when the radio between two devices is still on, or when the two phones are physically attached.

Collaborative Frame Decoding

Half-frame decoding is used as an example to represent exemplary decoding for mobile devices in which the frame is partitioned into fractional parts, such as half-frame, quarter-frame, etc. But to understand exemplary collaborative fractional-frame decoding, it is first helpful to describe and compare the various pros and cons and feasibility of other techniques that could be considered for aggregating video display over multiple mobile devices.

There are many possible ways to achieve video playback on two screens. To facilitate description, two mobile devices are referred to as M_{A} and M_{B}, with M_{A} being the content host. Mobile device M_{A} can be thought of as being on left and mobile device M_{B} on the right. The primary goal in this scenario is to achieve real-time playback of a video at doubled resolution on the computationally constrained mobile devices.

In full-frame decoding-based approaches, the most straightforward solution might be either to let M_{A} decode the entire frame, display the left half-frame and send the decoded right half-frame to M_{B} via network, or to let M_{A} send the entire bitstream to M_{B} and have both devices perform full-frame decoding, but display only their own respective half-frames. These two theoretical techniques might be called a thin client model and a thick client model, respectively.

The benefits of these two full-frame techniques are their simplicity of implementation. However, for the thin client model, the computing resources of M_{B} are not utilized and its huge bandwidth demand is prohibitive. For example, it would require more than 22 Mbps to transmit a 24 frame per second (fps) 320×240 sized video using YUV format (the bandwidth requirement doubles if RGB format is used). The energy consumption would be highly unbalanced between the two devices and therefore would lead to short operating time since the application would fail when the battery of either device ran out of charge. The thick client model requires much less bandwidth and utilizes the computing power of both devices. However, it overtaxes the computing power to decode more content than necessary, which can lead to both devices not achieving real-time decoding of the double resolution video. The reason for this is that the computational complexity of video is in direct proportional to its resolution if the video quality remains the same, but mobile devices are usually cost-effectively designed such that their computing power is just sufficient for real-time playback of a video that has a resolution that is no larger than that of the screen. Thus, the full-frame decoding-based approaches are not feasible.

Another category of solutions for partitioning video in order to aggregate video display is to allow each device to decode their corresponding half-frames. These half-frame techniques aggregate and utilize both devices' computing power economically. There are two alternative half-frame approaches that differ in transmitting whole or only partial bitstreams. These two approaches can be referred to as whole-bitstream transmission (WTHD) and partial-bitstream transmission (PTHD). Both half-frame approaches may reduce decoding complexity since only half-frames need to be decoded. However, as will be elaborated shortly, achieving half-frame decoding is challenging and can require substantial modification of the decoding logic and procedure. Partial bitstream transmission PTHD saves about half of the transmission bandwidth, which is significant, as compared with whole bitstream transmission WTHD, but adds to implementation complexity because of the bitstream parsing process to extract the partial bitstream for M_{B}.

While both half-frame schemes are feasible, from an energy efficiency point of view, partial bitstream transmission PTHD is more preferable since there is no bandwidth waste, i.e., only the bits that are strictly necessary are transmitted, which directly translates to energy savings. In one implementation, the collaborative architecture 116 adopts partial bitstream transmission PTHD. More specifically, the bitstream pre-parser 230 parses the bitstream into two partial ones, and the host mobile device 102 streams one of the resulting bitstreams to the other device 104. Both devices perform collaborative decoding. Much of the following description focuses on achieving and improving partial bitstream transmission PTHD in the context of the limited resources of mobile devices, especially the constraint of energy efficiency.

Even though the two half-frame approaches just described may be feasible, the feasibility does not guarantee an ability to perform half-frame decoding. Half-frame decoding is far more difficult than it might appear at first glance, because of the inherent temporal frame dependency of video coding caused by prediction, and possible cross-device references caused by visual motion in the video at the boundary between the two displays 106 and 108 being aggregated (i.e., references to the previous half-frame on the other device). In a worst case, the collaborative architecture 116 may still need to decode all frames in their entirety from the previous anchor frame (last frame that is independently decodable) in order to produce the correct references for some blocks in a very late frame.

Motion in the video provides some challenges. While recursive temporal frame dependency creates barriers for parallel decoding along the temporal domain, it also indirectly affects the task of performing parallel decoding in the spatial domain, i.e., in which the two devices M_{A} and M_{B} decode the left and right half-frames, respectively. The real challenge arises from the motion, but is worsened by the recursive temporal dependency.

Due to motion, a visual object may move from one half-frame to the other half-frame in subsequent frames. Therefore, dividing the entire frame into two half-frames creates a new cross-boundary reference effect. That is, some content of one half-frame is predicted from the content in the other half-frame. This implies that in order to decode one half-frame, the collaborative half-frame decoder 234 has to obtain the reconstructed reference of the other half-frame. But in order to decode an object at a position in the right half-frame, the mobile device M_{B} needs the reference data when the object was at a position in the left half-frame in the previous frame, which is unfortunately not available since device M_{B} displaying the right half of the video is not supposed to decode that information in the previous frame of the left half of the video. For mobile device M_{B} to decode the previous position of the visual object on the other half of the video would require, in the worst-case scenario, for M_{B} to decode all of the entire frames from the previous anchor frame in order to correctly decode a very late frame.

Exemplary Collaborative Half-Frame Decoding

There are still more techniques that can be used to perform efficient half-frame decoding. Needed references for decoding always exist in the decoded previous whole frame, therefore, a given reference either exists on the left half-frame or the right half-frame. Further, since the two mobile devices 102 and 104 have communication capability, the exemplary collaborative half-frame decoder 234 can make the reference data available via the two devices assisting each other, i.e., transmitting the missing references to each other. In other words, half-frame decoding can be achieved through cross-device collaboration.

The rationale for cross-device collaboration arises from the following two fundamental facts. First, motion compensated prediction exhibits a Markovian effect, that is, although recursive, the temporal frame dependency exhibits a first-order Markovian effect in which a later frame only depends on a previous reference frame, no matter how the reference frame is obtained. This enables cross-device collaboration and obtaining the correct decoding result. Second, the motion vector distributions and their corresponding cumulative distribution functions are highly skewed in a manner that can be exploited. When inspecting the motion vector distributions for the whole frames as well as those for only the two columns of macroblocks (referred to herein as the “guardband”) near the half-frame boundary. Only the horizontal component of motion vectors is responsible for cross-device references. Most motion vectors relevant to cross-device collaboration are very small. More than 80% of such motion vectors are smaller than 8 pixels, which is the width of a block. In fact, the distribution of motion vectors can be modeled by a Laplacian distribution. This fact implies that the traffic involved in the cross-device collaboration is likely to be affordable to the modest resources of a mobile communication device 102.

Half-Frame Decoding with Push-Based Cross-Device Collaboration

Collaborative half-frame decoding involves enabling each device to decode its respective half-frame and request the missing reference data from the other device. However, a practical barrier exists if cross-device helping data in the form of the missing references is obtained through natural on-demand pulling. This on-demand pull-based request of the missing reference data incurs extra delay and stalls the decoding process accordingly. This has a severely negative impact on the decoding speed and the overall smoothness of the playback. For example, for a 24 fps video, the average frame period is about 42 milliseconds. The round-trip time with WiFi is typically in the range of 10-20 milliseconds. Considering the extra time needed to prepare the helping data, the on-demand request scheme prevents timely decoding and is therefore not practical.

To overcome this barrier, in one implementation the collaborative half-frame decoder 234 uses instead a push-based cross-device helping data delivery scheme by looking ahead one frame. The purpose of looking ahead is to analyze what the missing reference data will be for both devices 102 and 104 through motion vector analysis. In this manner, the collaborative half-frame decoder learns in advance what reference data are missing for both devices 102 and 104 and ensures that this data will be sent as helping data.

In one implementation, the collaborative half-frame decoder 234 performs as follows. Before decoding the half-frame of the nth frame, the content hosting device 102 looks ahead by one frame through a lightweight pre-scanning process and performs motion analysis on the next, subsequent (n+1)th frame. The blocks that will reference the other half-frame in the subsequent frame are marked (i.e., in both devices 102 and 104) and their positions and associated motion vectors are recorded. Based on such information, the collaborative half-frame decoder 234 of one device can easily infer the exact missing reference data for the other device.

Next, the half-frame decoder 234 decodes the respective half-frame but skips the marked blocks since they will not have the reference data yet, and prepares the helping data in the meantime. The helping data is sent out immediately or buffered till the end of the decoding process for the frame and sent in a batch. Then the collaborative half-frame decoder 234 of each device performs quick rescue decoding for the marked blocks.

The exemplary push-based data delivery and the exemplary collaborative half-frame decoding just described achieve real-time playback despite the computationally constrained mobile devices 102 and 104.

Optimizing Energy Efficiency For Mobile Device Collaboration

Although the collaborative half-frame decoder 234 performs real-time video playback across mobile devices 102 and 104, it is also highly desirable to prolong the operating time of an aggregated system 100 by minimizing energy consumption since mobile devices 102 and 104 are typically battery operated. Although in one implementation the collaborative data traffic is used to maximally reduce the computational load, there is also the possibility of an optimal trade-off between net computation reduction over the two or more mobile devices and the volume of the resulting cross-device traffic, which requires energy to transmit. These two energy-spending activities can be balanced to minimize overall energy expenditure.

In one implementation of the collaborative half-frame decoder 234, the missing reference contents are transferred between the two mobile devices 102 and 104. This may incur large bandwidth consumption and be the cause of greater energy consumption. Given a percentage of boundary blocks (i.e., the column of macroblocks neighboring the half-frame boundary) that perform cross-boundary reference, the bandwidth requirement of their cross-device collaborative traffic is not consistently proportional to the percentage of cross-device reference blocks. This is because across different videos, the motion vectors are different even though they are all referencing content on the other device. Thus, the bandwidth requirement of the helping data traffic is relatively high, reaching half of the bandwidth required for sending the half bitstream itself, because the cross-boundary referencing is still frequent. Since WiFi consumes a great deal of energy, the cross-device collaborative data traffic should be reduced.

To reduce the cross-device collaborative traffic, adaptive use of multiple radio interfaces can lead to significant energy savings. However, the extent to which the adaptation can be made is subject to an application's specific requirements. In one implementation, close proximity networking layer 206 uses a “Bluetooth-fixed” policy, which always uses Bluetooth. The fundamental reason is that the streaming data rate is low enough to use Bluetooth's throughput. Nevertheless, if a higher data rate is required, then collaborative architecture 116 activates WiFi for most of the time. The cross-device collaborative traffic has to be reduced enough to be eligible for adaptive use of multiple radio interfaces 210. This desire for energy efficiency leads to an exemplary guardband-based collaborative half-frame decoding technique.

Exemplary Optimized Decoder

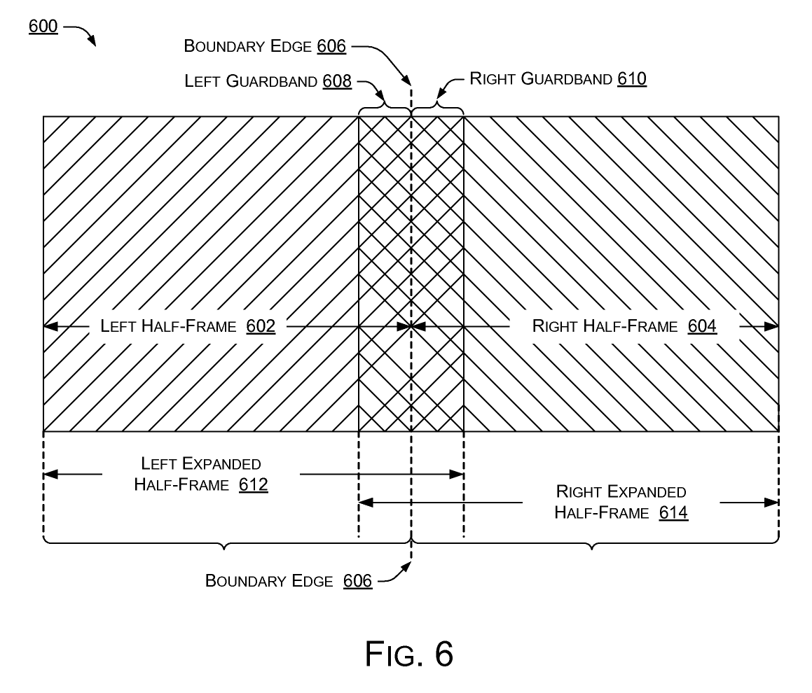

FIG. 6 shows exemplary video screen aggregation 600 of a left half-frame 602 and a right half-frame 604. From a motion vector distribution, it becomes evident that more than 90% of motion vectors are smaller than 16 pixels, which is the size of a macroblock. This implies that more than 90% of boundary blocks, i.e., macroblocks adjacent on each side to the boundary edge 606, can be correctly decoded without incurring any cross-device collaborative traffic if each mobile device 102 and 104 decodes an extra column of macroblocks (i.e., 608 and 610) across the boundary edge 606. These extra decoding areas, i.e., the extra columns of macroblocks 608 and 610 across the boundary edge 606 relative to a given half-frame 602 and 604, respectively, are referred to herein as guardbands 610 and 608.

The guardband-based collaborative half-frame decoder 234 in each mobile device 102 and 104 enables each respective device to not only decode its own half-frame 602 and 604, but also to decode an extra guardband 610 and 608 in order to reduce the cross-device collaborative data traffic. The half-frame areas plus the extra guardbands 608 and 610 are referred to as a left expanded half-frame 612 and a right expanded half-frame 614, as illustrated in FIG. 6. Decoding an extra guardband 610 and 608 in addition to the half-frame 602 and 604 significantly reduces the cross-device collaborative data traffic by as much as 75%.

The cross-device collaborative data traffic would not be reduced much if each device 102 and 104 had to decode the entire guardband 610 and 608 correctly. But the guardbands 610 and 608 do not have to be completely and correctly decoded. Blocks of the guardbands 610 and 608 are not shown on display screen 110 while those belonging to the half-frames are displayed. In fact, the collaborative half-frame decoder 234 only decodes those guardband blocks that will be referenced, which can be easily achieved via a motion analysis on the next frame. Furthermore, from fundamentals of video coding, the multiplicative decaying motion propagation effect suggests that the guardband blocks of one frame that are referenced by some boundary blocks of the next frame will have a much lower probability to reference to the area exterior to the guardband of its previous frame.

The exemplary guardband-based collaborative half-frame decoder 234 works as follows. Like collaborative half-frame decoding (non-guardband), the guardband-based half-frame decoder 234 also looks ahead by one frame, performs motion analysis, and adopts push-based cross-device collaborative data delivery. The difference lies in that each device 102 and 104 now decodes the extra guardband 608, 610. In one implementation, the half-frame decoder 234 differentiates the blocks in the guardband 608 and 610 according to their impact on the next frame: those not referenced by the next frame are not decoded at all; those referenced by the guardband blocks of the next frame are best-effort decoded, i.e., decoded without incurring cross-device collaborative data overhead and no assurance of correctness; and those referenced by the half-frame blocks of the next frame are correctly decoded with assurance, resorting to cross-device collaborative data as necessary.

The purpose of the guardbands 308 and 310 is not to completely remove the need for cross-device collaboration, but to achieve a better trade-off for purposes of energy efficiency and battery conservation by trading a significant reduction in the collaboration traffic for the cost of slightly more computations. To correctly decode an entire one-macroblock-wide guardband 608 (which represents the worst case, since in practice some non-referenced blocks need not to be decoded at all), the extra computational cost is about 7%, but the average associated cross-device collaborative data exchange savings is about 76%, which is favorable even when Bluetooth is used.

In the implementation just described, the exemplary half-frame decoder 234 empirically sets the width of each guardband 608 and 610 to be a one-macroblock column. This selection arises from simplicity of implementation because all motion compensation is conducted on a macroblock basis in MPEG-2, and supports real-time playback of the video. If the collaborative half-frame decoder 234 uses a two-macroblock-wide guardband 608 instead of a one-macroblock wide guardband, the expansion incurs another 7% computation overhead (in the worst case) but brings only an additional 10% cross-device traffic reduction. So, a wider guardband 608 is not necessarily very beneficial. Yet, in another implementation, the collaborative half-frame decoder 234 takes an adaptive approach, looking ahead for multiple frames (e.g., a group of picture, GOP), performing motion analysis, and determining the optimal guardband width for that specific GOP. However, a prerequisite condition may be knowledge at the resource coordinator 216 of energy consumption characteristics of the WiFi and the CPU or other processor in use, which may vary with different mobile devices. In one implementation, the guardband-based collaborative half-frame decoder 234 applies a profile-based approach to dynamically select guardband width.

CPU/Memory Aggregation

Another implementation of the collaborative architecture 116 aggregates the CPU processing power and memory of the two devices 102 and 104, to perform tasks that are otherwise not possible when the processing power of a single device is not enough for the task. By using the processing power of two or more mobile devices, parallelisms can be exploited to fulfill the task. For example, a SMARTPHONE may smoothly playback QVGA (320×240) video, but not be able to playback a 320×480 video. However, when two mobile devices are aggregated together, they can decode and display the 320×480 video smoothly. CPU/memory aggregation also enhances gaming experience simply because the aggregated device is more powerful.

Storage Aggregation

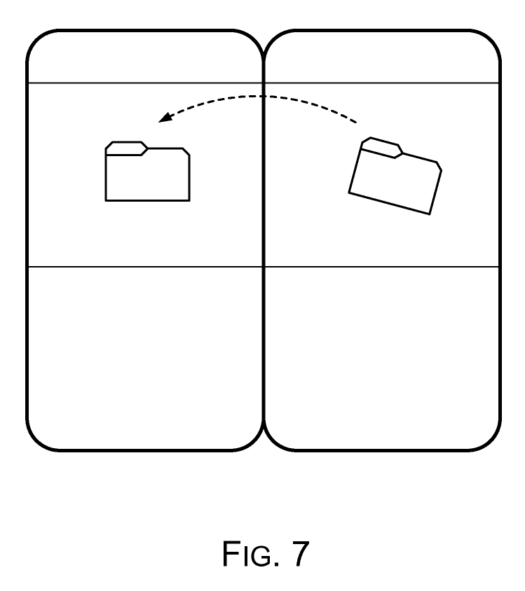

In one implementation, the collaborative architecture 116 treats one device's storage as external storage for the other device. The collaborating devices can also serve as backup devices for each other. This makes sharing files/folders easier because of the special relationship between the two mobile devices. Each mobile device can map the other as a virtual storage. This can be done easily when the two phones are physically attached and also possible when a wireless connection can be made between the two. When the two mobile devices 102 and 104 also have aggregated video display, then files can be moved from one device to the other by dragging and dropping the file or folder icon across the display screens, as shown in FIG. 7. The collaborative architecture 116 also supports delay-tolerant file operations. For example, a user can select files for copy to the other device when the devices are connected at a later time.

Battery Aggregation

When the two handheld devices can be physically attached either through cable or through hardware interfaces, the battery of one device can be the spare for the other, i.e., one battery can power up both devices when there is such need. This improves a current scenario in which a user has to forward incoming calls to another phone when the current phone runs out of power, and the user must do so before the battery is completely spent.

The call forwarding functionality is often charged by the service provider and currently only provides very limited functionality against a drained phone battery. For example, when the battery runs out of power, contextual data such as the address book will not be able to be used anymore in the current service. Even when the two phones are exactly the same, conventionally the only benefit for having two phones in the face of a drained battery is that the user can determine which phone to be using, by exchanging batteries. The exemplary aggregation of battery resources, on the other hand, can solve this limitation.

Radio/Antenna Aggregation

An exemplary system with aggregated resources can use one radio/antenna instead of two to save energy. For example, the system can use a lower power radio (e.g., GSM/GPRS or BlueTooth) instead of WiFi, or may not use a second radio at all if the two devices are physically connected, instead of using a high power radio (e.g., WiFi) to keep the devices connected to the Internet or to keep the devices discoverable. This is especially helpful for the cases in which a low bandwidth radio suffices for application requirements such as for VOIP applications. The high power and high bandwidth radio (e.g., WiFi) can be awakened on demand by using the low power radio.

In demanding high bandwidth cases, an exemplary system can readily achieve larger (close to double) bandwidth by leveraging both radio/antennas from the two devices. In even higher bandwidth-demand cases, the exemplary system has the potential to use cooperative diversity techniques to achieve larger than double bandwidth. The system may also achieve a large bandwidth by simultaneously using the multiple radios of a phone including GPRS (or CDMA1x), BlueTooth, WiFi, InfraRed, etc.

The exemplary system also supports the well-studied Internet connection sharing (ICS) application where one phone can use a short-range radio to leverage the other's Internet access, which is via long-range radio like GPRS/CDMA1x.

Other Aggregation Scenarios

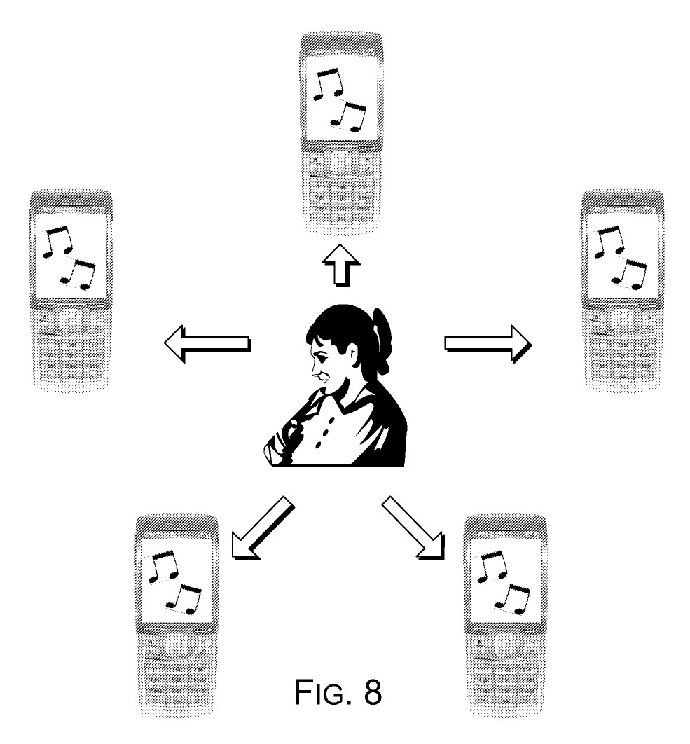

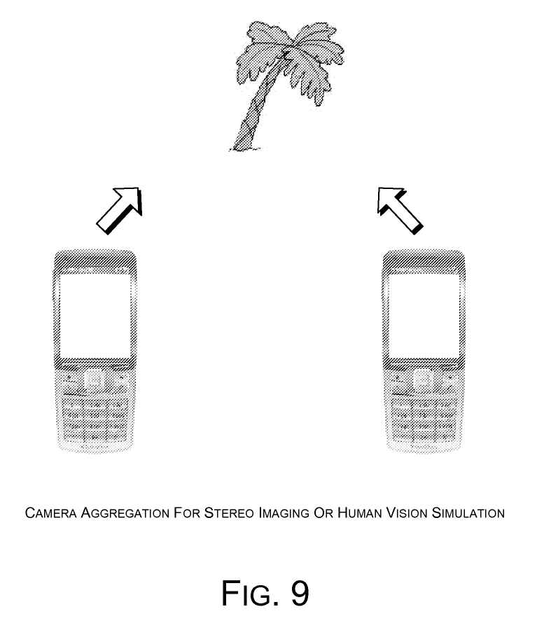

The exemplary collaborative architecture 116 can provide other resource aggregation scenarios:
FIG. 8 shows multiple microphone aggregation across multiple mobile devices: an exemplary system can perform stereo recording, and may support other microphone-array enabled applications such as determining the speaker's position, etc.
FIG. 7 also shows speaker aggregation: an exemplary system can form stereo audio playback by aggregating the speakers from the two handheld devices. It can also form an “orchestra” or surround-sound if more than two mobile devices are available.
FIG. 9 shows exemplary camera aggregation. An exemplary system can perform stereo video capturing. For example, two mobile devices 102 and 104 can be placed together so that the distance between the two lenses is very close to the interaxial spacing of human eyes and results in a natural simulation of human vision. The focus settings of both cameras can be software controlled and operate in a synchronized manner. In another application, the two cameras can be used for super-resolution applications. That is, the two cameras take pictures of the same object from natural slightly offsetting angles and apply signal processing methods to obtain higher-resolution pictures or videos.
Keypad aggregation: input can be enhanced when keypads/keyboards are aggregated to provide more keys. Or, the aggregation can make the resulting keyboard larger and more natural. If more than two mobile devices are aggregated, the collaborative architecture 116 can turn the combined keypads into a Qwerty-like keyboard. For mobile devices with touch screens, the aggregated larger screen will provide a more user-friendly keyboard layout, for example, by making each button larger.

Security Enhancement

In one implementation, the collaborative architecture 116 includes a security manager to provide security enhancement, such as:
Physical security: important data are partitioned and stored into two physical devices 102 and 104.
Mutual care: one device 102 can scan the other device 104 for security issues and cure the other device 104 if compromised.

Two mobile devices 102 and 104 can be optionally installed with the security manager to divide and encrypt information that needs to be protected into two parts. Then each part is stored on a separate mobile device. Only when the two phones are placed in proximity of each other (or in a proximity that is close enough to prove the physical existence of the other) can the original secure information can be deciphered. Thus, when one of the devices is lost, the information remains secure.

The security manager can manage the two (or more) mobile devices 102 and 104 so that each can scan and cure the other if the other becomes compromised. Again, the number “two” here can be generalized to multiple devices.

Proximity Detection

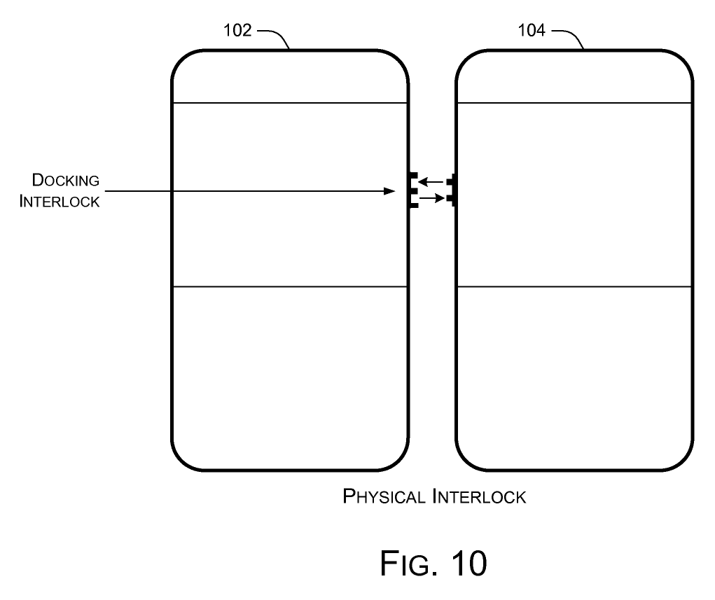

The proximity detector 212 has a primary function of ensuring a close proximity with another mobile device for purposes of aggregating resources (e.g., combining display screens into one). As described above, approximate or precise proximity information can be obtained at different system complexities. In some circumstances, the proximity detector 212 can use physical connections such as the hardware interconnect shown in FIG. 10, or physical proximity sensors, such as magnetic proximity switches.

For typical applications, the collaborative architecture 116 can use a simple radio signal strength-based strategy to determine a rough estimate of distance between mobile devices 102 and 104, thereby involving only wireless signals. Typically, radio signal strength is indicated by receiving a signal strength index (RSSI), which is usually available from wireless NIC drivers. If high precision is desired, then with additional hardware the collaborative architecture 116 can use both wireless signals and acoustic or ultrasonic signals to obtain precision up to a few centimeters.

The proximity detector 212 can use acoustic ranging alone or to augment other proximity detection methods such as radio signal strength techniques. Proximity detection by acoustic ranging techniques is described in the aforementioned U.S. patent application Ser. No. 11/868,515 to Peng et al., entitled “Acoustic Ranging,” filed Oct. 7, 2007 and incorporated herein by reference.

Exemplary Methods

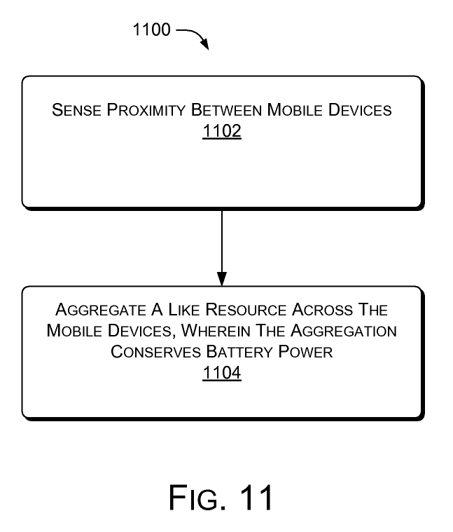

FIG. 11 shows an exemplary method 800 of mobile device collaboration. In the flow diagram, the operations are summarized in individual blocks. The exemplary method 1100 may be performed by combinations of hardware, software, firmware, etc., for example, by components of the exemplary collaborative architecture 116.

At block 1102, proximity between two mobile devices is sensed. A proximity threshold can be used to toggle between an aggregation mode, in which two or more mobile devices coalesce their resources, and a separation mode, in which each mobile device functions as a standalone device. In exemplary video display aggregation, the method 1100 accordingly switches between full-frame decoding for when the mobile devices are functioning as standalone units, and partial-frame decoding (such as half-frame decoding), in which each mobile device decodes its share of the video to be displayed on its own display screen. Detecting proximity can be accomplished via a physical interlock, by sensing radio signal strength, by acoustic ranging, or by a combination of the above.

At block 1104, like resources of the two mobile devices are aggregated in such a manner as to best conserve the battery power of the mobile devices. In one implementation, two mobile devices aggregate their capacity to play a video bitstream, aggregating their display hardware and their decoders via a collaborative architecture. This involves receiving a video bitstream at the first mobile device, parsing the video bitstream into partial bitstreams for playing on each side of the combined displays of the two mobile devices, and transferring the second partial bitstream to the second mobile device.

Each mobile device decodes its respective partial bitstream and then collaborates with the other device as to how to decode visual content to be shown on its display when the content depends on prediction from motion references in the partial bitstream owned by the other mobile device. The method 1100 includes applying a cross-display motion prediction that, in order to conserve battery energy, balances an amount of collaborative communication between the mobile devices with an amount of processing at each mobile device needed to display visual motion across the boundary between displays.

The method 1100 applies push-based cross-device data delivery that is based on looking ahead one video frame via motion vector analysis to analyze missing motion prediction references for both mobile devices. By learning in advance the motion prediction reference data that will be missing for both devices, each device can collaboratively send the motion prediction reference data to help the other device decode blocks near the display boundary.

In one implementation, the method 1100 marks blocks that refer to video frames on the other device. Then, the method 1100 can skip decoding blocks for which no prediction references are available, until helping data containing the references is received from the other device.

In one implementation, the method 1100 decodes an extra guardband column of macroblocks of the other device's partial video frame near the display boundary to reduce the cross-device data traffic. Only blocks of each guardband that will be referenced for motion prediction need to be decoded. Further, the method 1100 differentiates the blocks in the guardband according to their impact on the next video frame. When guardband blocks are not referenced by the next video frame they are not decoded at all. Blocks referenced by the guardband blocks of the next video frame are decoded without incurring cross-device data overhead and have no assurance of correctness. Blocks referenced by the visible video frame blocks of the next video frame are correctly decoded, with assurance of correctness provided by using the motion prediction references sent in the cross-device helping data.

The method 1100 balances the energy expenditure of cross-device collaboration against the energy expenditure of the local processing needed to successfully achieve cross-display visual movement, thereby achieving low battery drain.

### Conclusion

Although exemplary systems and methods have been described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A method, comprising:
receiving a video bitstream at a first mobile device;
sensing a proximity of a second mobile device;
based on sensing the proximity, parsing the video bitstream into a first partial bitstream for playing a first visual part of the video on a display screen of the first mobile device and into a second partial bitstream for playing a second visual part of the video on a display of the second mobile device;
transferring the second partial bitstream from the first mobile device to the second mobile device;
decoding the first partial bitstream at the first mobile device and decoding the second partial bitstream at the second mobile device; and
collaborating between the first and second mobile devices to decode visual content to be displayed on one mobile device based on motion prediction references in the partial bitstream of the other mobile device.

2. The method as recited in claim 1, further comprising minimizing battery consumption by applying a cross-display motion prediction that balances an amount of collaborative communication between the mobile devices during the collaborating with an amount of processing at each mobile device for displaying visual motion across the boundary between displays.

3. The method as recited in claim 1, wherein the decoding conserves stored energy in the mobile devices by optimizing a balance between:
an energy cost of decoding the visual content displayable on one mobile device that has motion prediction references in the partial bitstream of the other mobile device; and
an energy cost of the collaborating, including transferring motion prediction references between the mobile devices.

4. The method as recited in claim 1, further comprising aggregating the displays of the first and second mobile devices into one visual display and playing the first partial bitstream on the display of the first mobile device while playing the second partial bitstream on the display of the second mobile device.

5. The method as recited in claim 1, further comprising applying push-based cross-device helping data delivery based on looking ahead one video frame.

6. The method as recited in claim 5, wherein the looking ahead analyzes missing motion prediction reference data for both mobile devices via motion vector analysis.

7. The method as recited in claim 6, further comprising learning in advance the motion prediction reference data that will be missing for both devices and sending the motion prediction reference data as the helping data during the collaborating.

8. The method as recited in claim 7, wherein before decoding a partial video frame of the nth video frame:
looking ahead by one video frame via a lightweight pre-scanning process and performing motion analysis on the subsequent (n+1)th video frame;
marking blocks of the nth video frame that will reference the other partial video frame in the subsequent (n+1)th video frame;
recording positions and associated motion vectors of the marked blocks;
inferring the missing motion prediction reference data of the other mobile device from the recorded positions and associated motion vectors.

9. The method as recited in claim 8, further comprising:
skipping the marked blocks during decoding;
preparing the helping data for the collaborating;
exchanging the helping data between the mobile devices; and
decoding the marked blocks using the helping data.

10. The method as recited in claim 9, further comprising, at each mobile device, decoding an extra guardband of macroblocks of the other partial video frame of the other mobile device, wherein decoding an extra guardband in addition to the partial video frame reduces cross-device collaborative helping data traffic.

11. The method as recited in claim 10, further comprising decoding only blocks of each guardband that will be referenced for motion prediction.

12. The method as recited in claim 11, further comprising differentiating the blocks in the guardband according to an impact on the next video frame, wherein blocks not referenced by the next video frame are not decoded at all, blocks referenced by the guardband blocks of the next video frame are decoded without incurring cross-device collaborative data overhead and with no assurance of correctness, and blocks referenced by the partial video frame blocks of the next video frame are correctly decoded with assurance of correctness using the cross-device collaborative helping data.

13. The method as recited in claim 1, further comprising adaptively using multiple radio interfaces for the collaborating in order to conserve energy, wherein a data rate determines whether a Bluetooth radio interface, a WiFi radio interface, or a combination of Bluetooth and WiFi radio interfaces are activated for the collaborating.

14. A system, comprising:
a mobile device; and
a collaborative architecture in the mobile device for aggregating first resources of the first mobile device with second resources of a second mobile device.

15. The system as recited in claim 14, further comprising:
an adaptive video decoder in the collaborative architecture for parsing a video bitstream into a first partial bitstream for playing a first visual part of the video on a display screen of the first mobile device and into a second partial bitstream for playing a second visual part of the video on a display of the second mobile device; and
a cross-display motion predictor to save battery power by reducing an amount of collaborative communication between devices and an amount of processing at each device needed to display motion across a boundary between displays.

16. The system as recited in claim 15, wherein the cross-display motion predictor performs cross-device video rendering to optimize a balance between the processing cost of rendering the video at the boundary between respective displays of the mobile devices and the transmission cost of exchanging, between the mobile devices, motion prediction references that apply across the boundary.

17. The system as recited in claim 15, further comprising a proximity detector to determine when the second mobile device is near enough to aggregate resources.

18. The system as recited in claim 15, further comprising a resource coordinator to discover resources of the second mobile device and inventory a processing power and a communication ability of the second mobile device.

19. A system, comprising:
means for sensing a proximity between two mobile devices; and
means for aggregating similar resources of each mobile device in such manner as to conserve battery power of the mobile devices.

20. The system as recited in claim 19, further comprising means for playing back a video across the aggregated display screens of the two mobile devices while minimizing battery consumption used for cross-display motion prediction.
